(19) United States
(12) Patent Application Publication
(10) Pub. No.: US 2014/0012955 A1
(43) Pub. Date: Jan. 9, 2014

(54) Communication System, Communication Device, And Communication Method

(71) Applicants: Hiroyuki Shoji, Kanagawa (JP); Naoki Yuasa, Chiba (JP)

(72) Inventors: Hiroyuki Shoji, Kanagawa (JP); Naoki Yuasa, Chiba (JP)

(73) Assignee: SONY CORPORATION, Tokyo (JP)

(21) Appl. No.: 14/006,203

(22) PCT Filed: Feb. 16, 2012
(86) PCT No.: PCT/JP2012/053682

§ 371 Date: Sep. 19, 2013

(30) Foreign Application Priority Data
Mar. 31, 2011 (JP) 2011-078463

(51) Int. Cl. H04L 29/06

(52) U.S. Cl. CPC H04L 65/60
USPC 709/219

(57) ABSTRACT

Sufficient meta-information related to live content is favorably provided to devices.

An expanded CDS for content information being delivered is defined, which is used for including detailed content information of content being delivered, separately from a standard CDS accessed during content browsing. In the expanded CDS for content information being delivered, a container is provided for each client of delivery destination, and a content node being delivered is arranged under the each delivery destination container node. A rule related to the expanded CDS for content information being delivered is shared with the client, so that the client can identify information of the expanded CDS for content information being delivered of the content that the client itself is reproducing.

### TECHNICAL FIELD

The technology disclosed in the present specification relates to a communication system, a communication device, and a communication method that performs a content delivery service in accordance with DLNA standard, and especially, relates to a communication system, a communication device, and a communication method that provides meta-information of content by a CDS function.

### BACKGROUND ART

Recently, most of AV content has been digitalized, and a medium that records and reproduces digital content, such as a CD and a DVD, have been widely used. In addition, a distribution/delivery service of content, such as images and music, through a network has become popular, and content delivery is performed between remote terminals through the network without transference of a medium, such as a CD and a DVD. Further, Digital Living Network Alliance (DLNA) has been standardized, in which AV content digitalized based on universal plug and play (UPnP) that enables participation to the network by only connecting devices to the network is distributed at home through an internet protocol (IP) network. With the fact above, products having functions complying with the DLNA standard and the UPnP standard have been increased in consumer electronics (CE) devices centering on audio-video equipment, and a personal computer (PC) and peripheral devices thereof (for example, a network attached storage (NAS) and the like).

In DLNA Guideline 1.0 (and 1.5) formulated several years ago, a connection condition of 2-Box Pull system (systemusage) made of a digital media server (DMS) corresponding to a server that provides content and a digital media player (DMP) corresponding to a client that reproduces the content was defined. With the release of the guideline, products equipped with DMS and DMS functions have been mainly spread. Further, in recently formulated DLNA Guideline 1.5, 3-Box System Usage has been defined, in which the client is made of a digital media renderer (DMR) and a digital media controller (DMC). The DMC is controlled, so that content can be transmitted from the DMS to the DMR and can be reproduced. With the release of the guideline, products equipped with DMR and DMC functions have appeared.

In most cases, the DMS delivers content stored in the own storage either in 2-Box Pull or 3-Box System Usage. In UPnP, which is a base of DLNA, a content directory service (CDS) function is formulated, in which a list of content provided by a DMS and detailed information of the content are layered and delivered. When the CDS is incorporated in DLNA, if content to be delivered is stored in the DMS as described above, it is possible to construct the CDS from the stored content in advance. The CDS standard is formulated on the assumption that the DMS stores the content to be delivered in the own storage, that is, the DMS treats static information.

Meanwhile, with the spread of a broadband, in the field of an internet service, services that deliver streaming of music and video content have been increased. It is believed that the demand of the DMS function will be increased in the days ahead, in which internet content, digital audio broadcast (DAB) having been spread mainly in Europe and the United States, and conventional analog or digital radio broadcasting content are received and are delivered to home devices (DMP, DMC, and DMR). In other words, each of the devices (DMP, DMC, and DMR) does not directly receive such services and broadcasting content, and one device having the DMS function receives the services and content, serving as a kind of proxy server, and delivers the services and content to other client devices. With such a utilization form, there is an advantage that the client devices such as a DMP, DMC, and DMR do not need a software module in which an authentication sequence for directly receiving the above services is incorporated, and hardware such as a tuner that receives broadcasting.

However, when a device having the DMS function delivers content being received in real-time (hereinafter, referred to as “live content”) to the client devices, in many cases, the client devices cannot obtain information accompanying the content without actually receiving the services and the broadcasting content. In contrast, a typical CDS has a problem such that the CDS cannot release further detailed information about the live content because it is assumed that the CDS treats previously obtainable static information as described above. In this case, compared with the case of directly receiving the services and the broadcasting content, meta-information that can be displayed at the client device side is reduced, resulting in deterioration in usability.

For example, a method of providing content has been proposed, in which a first device that provides content received from a content server to a second device updates a content list of a CDS having an UPnP AV structure (for example, see Patent Document 1). However, the detailed information of the content is not updated, and thus, the method cannot get out of the deterioration of usability.

### CITATION LIST

Patent Document
Patent Document 1: JP 2008-21293 A

### SUMMARY OF THE INVENTION

### Problems to be Solved by the Invention

An objective of the technology disclosed in the present specification is to provide a superior communication system, communication device, and communication method capable of favorably performing a content delivery service in accordance with the DLNA standard.

Another objective of the technology of the present specification is to provide a superior communication system, communication device, and communication method capable of favorably providing meta-information of content from a DMS to devices by a CDS function.

Another objective of the technology disclosed in the present specification is to provide a superior communication system, communication device, and communication method capable of favorably providing sufficient meta-information related to live content received by a DMS in real-time and delivered by a DMS to devices.

### Solutions to Problems

The present specification discloses a technique made in view of the above problem, and a technique described in claim 1 is a communication system including:

a server configured to operate in accordance with DLNA standard to deliver content; and

a client configured to operate in accordance with the DLNA standard to request delivery of content,

wherein the server creates an expanded CDS for content information being delivered in which a delivery destination container node having an ObjectID based on information identifying the client is arranged directly under a root, and a content node being delivered is arranged under the delivery destination container node, and extracts content detailed information from content that has acquired to deliver to the client and stores the content detailed information in the content node being delivered.

Note that the “system” here refers to a logical set of a plurality of devices (or functional modules that realize specific functions), and whether the devices or functional modules are in a single housing is not particularly considered.

Further, a technique described in claim 2 of the present application is a communication device configured to operate as a server in accordance with DLNA standard, including:

a communication unit configured to communicate with an external device;

a content acquisition unit configured to acquire content requested from a client;

a content providing unit configured to deliver the content to the client;

a CDS information generation unit configured to generate CDS information related to the content; and

a CDS information providing unit configured to transmit the CDS information by a request from the client,

wherein, in response to a request of providing content from the client, the CDS information generation unit arranges a delivery destination container node having an ObjectID based on information identifying the client directly under a root of an expanded CDS for content information being delivered, and creates a content node being delivered under the delivery destination container node, and extracts content detailed information from the content acquired by the content acquisition unit and stores the content detailed information in the content node being delivered, and

in response to a request of CDS information from the client to which the content providing unit is delivering the content, the CDS information providing unit transmits CDS information including the content detailed information stored in the appropriate content node being delivered.

According to a technique described in claim 3 of the present application, in the communication device according to claim 2, wherein the content node being delivered has res information that accords with a URL of the content.

According to a technique described in claim 4 of the present application, the communication device according to claim 2 is configured such that, when the content providing unit completes delivery of the content to the client, each node is deleted from the expanded CDS for delivery content information.

According to a technique described in claim 5 of the present application, the content acquisition unit of the communication device according to claim 2 is configured to acquire live content from a provider over an outside network through the communication unit, and when the live content is requested from the client, the CDS information generation unit is configured to create the delivery destination container node and the content node being delivered in the expanded CDS for content information being delivered.

According to a technique described in claim 6 of the present application, the communication device according to claim 2 further includes a content accumulation unit configured to accumulate content to be provided to the client. When the content accumulated in the content accumulation unit is requested from the client, the CDS information generation unit creates the delivery destination container node and the content node being delivered in the expanded CDS for content information being delivered.

Further, a technique described in claim 7 of the present application is a communication device configured to operate as a client in accordance with DLNA standard, at least including:

a communication unit configured to communicate with a device that is in accordance with the DLNA standard; and

a CDS information browsing unit configured to request browsing of CDS information to a server that is in accordance with the DLNA standard,

wherein the CDS information browsing unit generates an ObjectID based on information identifying the CDS information browsing unit itself, and requests browsing of CDS information to the server using the ObjectID.

According to a technique described in claim 8 of the present application, the communication device according to claim 7 is a DMP defined in the DLNA standard, and further includes a content acquisition unit configured to request content to the server to acquire the content, a content decoding unit configured to decode the content, and a content reproduction output unit configured to reproduce/output the decoded content. The content acquisition unit requests live content provided by a provider to the server, the CDS information browsing unit generates an ObjectID based on information identifying the CDS information browsing unit itself, and requests browsing of CDS information to the server using the ObjectID.

According to a technique described in claim 9 of the present application, the communication device according to claim 7 is a DMC defined in the DLNA standard, and further includes a content reproduction request unit configured to request reproduction/output of content to a renderer. The content reproduction request unit requests reproduction of live content provided by a provider to the renderer, the CDS information browsing unit generates an ObjectID based on information identifying the CDS information browsing unit itself, and requests browsing of CDS information to the server using the ObjectID.

Further, a technique described in claim 10 of the present application is a communication method for operating as a server in accordance with DLNA standard, the method including:

a step of arranging a delivery destination container node having an ObjectID based on information identifying a client directly under a root of an expanded CDS for content information being delivered, and creating a content node being delivered under the delivery destination container node, in response to a request of providing content from the client;

a step of acquiring the content requested from the client;

a step of extracting content detailed information from the acquired content and storing the extracted content detailed information in the content node being delivered;

a step of delivering the acquired content to the client; and

a step of transmitting CDS information including the content detailed information stored in the appropriate content node being delivered, in response to a request of CDS information from the client to which the content is being delivered.

Further, a technique described in claim 11 of the present application is a communication method for operating as a client in accordance with DLNA standard, the method including:

a step of generating an ObjectID based on information identifying a communication device itself; and

a step of requesting browsing of CDS information to the server using the ObjectID.

### Effects of the Invention

According to the technology disclosed in the present specification, a superior communication system, communication device, and communication method capable of favorably providing sufficient meta-information related to live content received in real-time and delivered to devices by a DMS.

According to the technology disclosed in the present specification, one device such as a DMS can release more detailed information regarding live content to be delivered to devices (DMP, DMC, DMR) by serving as a kind of proxy server, whereby the usability can be improved.

Other objectives, characteristics, advantages of the technology disclosed in the present specification will become clear from the following more detailed description based on the embodiments below and the attached drawings.

### BRIEF DESCRIPTION OF DRAWINGS

FIG. 1 is a diagram illustrating a configuration example of a communication system based on 2-Box Pull system (system usage) defined by DLNA Guideline 1.0.

FIG. 2 is a diagram illustrating a communication system based on 3-Box System Usage defined by DLNA Guideline 1.5.

FIG. 3 is a functional block diagram of a device that operates as a DMS.

FIG. 4 is a functional bock diagram of a device that operates as a DMP.

FIG. 5 is a functional block diagram of a device that operates as a DMC.

FIG. 6 is a functional block diagram of a device that operates as a DMR.

FIG. 7 is a diagram illustrating an example of a communication sequence for performing content browsing and content reproduction by the DMP when the DMS delivers content stored in the own storage to the DMP in the 2-Box Pull System Usage.

FIG. 8 is a diagram illustrating an example of a communication sequence for performing content browsing and content reproduction by the DMP when the DMS delivers live content acquired from a provider to the DMP in the 2-Box Pull System Usage.

FIG. 9A is a diagram illustrating an example of a communication sequence for performing content browsing in the DMC when the DMS delivers content stored in the own storage in the 3-Box System Usage.

FIG. 9B is a diagram illustrating an example of a communication sequence for performing content reproduction in the DMR when the DMS delivers content stored in the own storage in the 3-Box System Usage.

FIG. 10A is a diagram illustrating an example of a communication sequence for performing content browsing in the DMC when the DMS delivers live content acquired from a provider in the 3-Box System Usage.

FIG. 10B is a diagram illustrating an example of a communication sequence for performing content reproduction in the DMR when the DMS delivers live content acquired from a provider the in 3-Box System Usage.

FIG. 11 is a diagram illustrating an example of a CDS configuration provided with a CDS tree for including content detailed information of content being delivered, separately from a CDS tree accessed during content browsing.

FIG. 12A is a diagram illustrating an example of a communication sequence in which the DMP performs content reproduction when the DMS delivers live content acquired from a provider to the DMP in the 2-Box Pull System Usage.

FIG. 12B is a diagram illustrating an example of a communication sequence in which the DMP performs content reproduction when the DMS delivers live content acquired from a provider to the DMP in the 2-Box Pull System Usage.

FIG. 13A is a diagram illustrating an example of a communication sequence in which content reproduction is performed in the DMR when the DMS delivers live content acquired from a provider in the 3-Box System Usage.

FIG. 13B is a diagram illustrating an example of a communication sequence in which content reproduction is performed in the DMR when the DMS delivers live content acquired from a provider in the 3-Box System Usage.

### MODE FOR CARRYING OUT THE INVENTION

Hereinafter, embodiments according to the technology disclosed in the present specification will be described in detail with reference to the drawings.

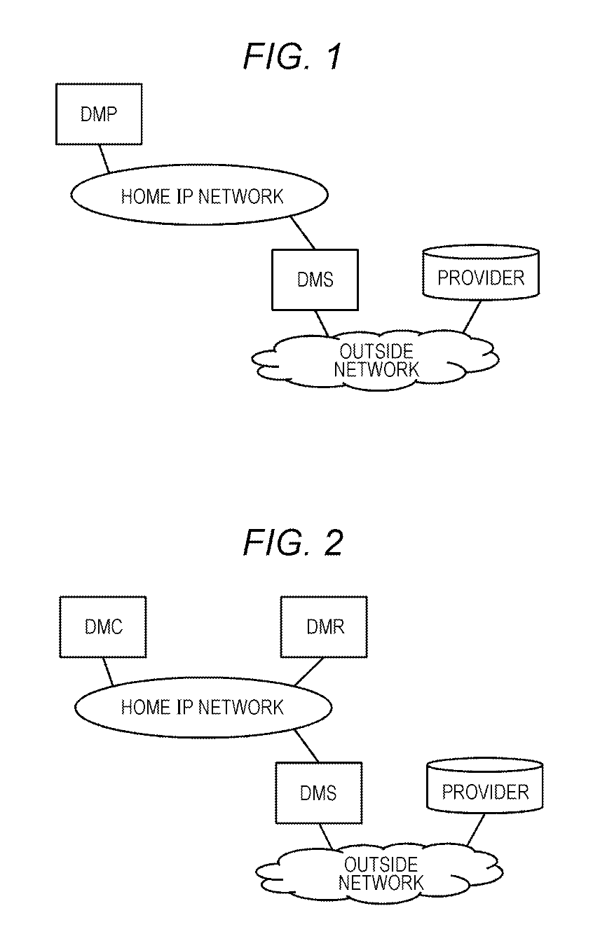

FIG. 1 illustrates a configuration example of a communication system based on the 2-Box Pull system (system usage) defined by DLNA Guideline 1.0. A DMS that provides content through a home IP network, and a DMP that reproduces the content received through the home IP network are connected over the IP network laid at home according to a predetermined connection condition. The DMS provides static content stored in an own storage. Further, the DMS is also connected to an outside network such as the Internet, and can provide live content obtained from a provider over the outside network. Note that the “provider” here refers to a supplier who provides services and content.

In the illustrated communication system, a CDS function formulated in UPnP is incorporated. Detail thereof will be described below. Note that, for simplification of the drawings, only one DMS and DMP each are drawn in FIG. 1. However, two or more DMSs and DMPs may be connected to the home IP network.

Further, FIG. 2 illustrates a configuration example of a communication system based on the 3-Box System Usage defined by DLNA Guideline 1.5. A DMS that provides content through a home IP network, a DMR that reproduces the received content through the IP network, and a DMC that operates the DMR are connected over the IP network laid at home according to a predetermined connection condition. The DMS provides static content stored in an own storage. Further, the DMS is also connected to an outside network such as the Internet, and can provide live content obtained from a provider (content server) over the outside network. In the illustrated communication system, a CDS function formulated in UPnP is incorporated, and details thereof will be described below. Note that, for simplification of the drawings, only one DMS, DMC, and DMR each are drawn in FIG. 2. However, two or more DMSs, DMCs, and DMRs may be connected to the home IP network.

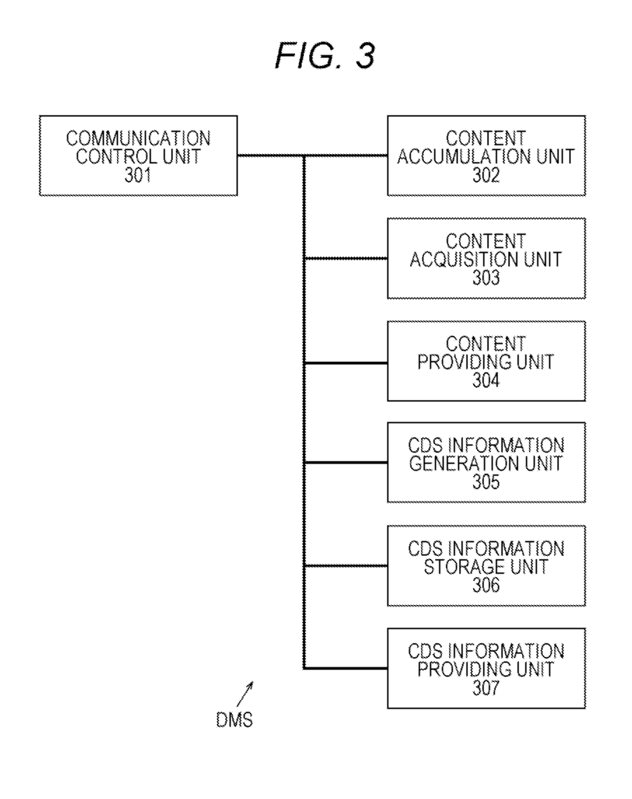

FIG. 3 schematically illustrates a functional configuration of a device that operates as the DMS in FIGS. 1 and 2. Hereinafter, each unit will be described.

A communication control unit 301 controls a communication operation through the home IP network and the outside network, and generally controls an overall operation of the devices.

A content accumulation unit 302 accumulates content to be provided to the DMP or to the DMR provided by the DMS itself. In addition, the content accumulation unit 302 includes an internal database that stores content information in advance, in which detailed information related to each pieces of the accumulated content is written.

A content acquisition unit 303 acquires live content requested from the DMP or from the DMR from the provider through the outside network.

A content providing unit 304 provides the static content accumulated in the content accumulation unit 302 and the live content acquired from the provider to the DMP or to the DMR as the requestor.

A CDS information generation unit 305 generates CDS information concerning the static content accumulated in the content accumulation unit 302 and the live content acquired from the provider. The generated CDS information is stored in a CDS information storage unit 306.

As for the static content accumulated in the content accumulation unit 302, all pieces of acquirable information related to the content can be acquired by accessing the internal database (described above). Therefore, the CDS information generation unit 305 can generate sufficient CDS information. In contrast, as for the live content, in most cases, only limited information such as a title of the content and the like can be acquired, although it varies according to the provider, and detailed information such as artist information and the like cannot obtained without actually acquiring content data itself. Therefore, the CDS information generation unit 305 generates, concerning the live content before acquisition, the CDS information made of limited information. Note that details of a data structure of the CDS information to be stored in the CDS information storage unit 306 will be described below.

A CDS information providing unit 307 provides the CDS information stored in the CDS information storage unit 306 in response to an acquisition request of the CDS information from the DMP or the DMC.

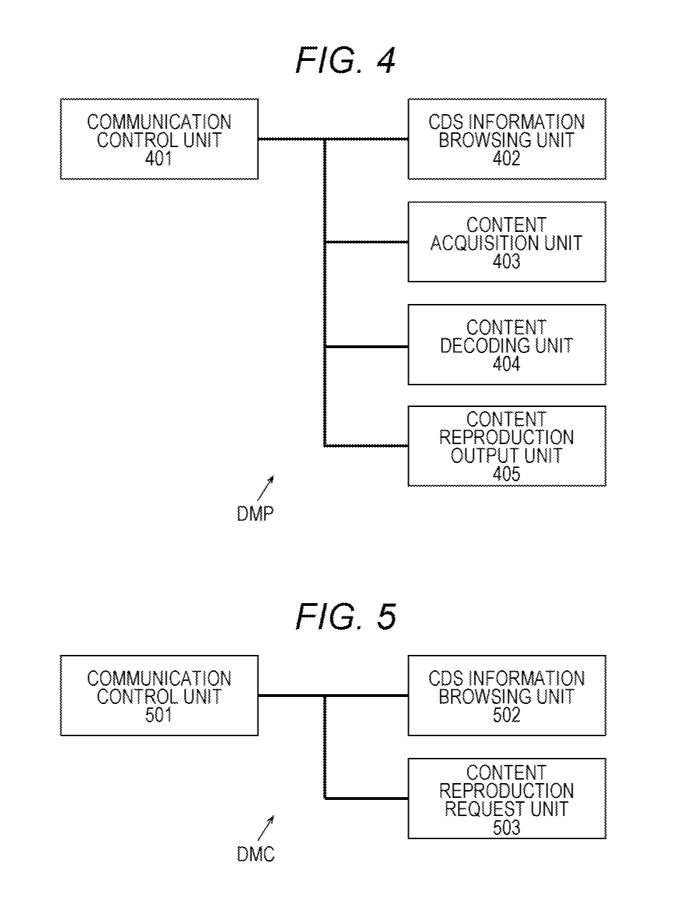

FIG. 4 schematically illustrates a functional configuration of a device that operates as the DMP in FIG. 1. Hereinafter, each unit will be described.

A communication control unit 401 controls a communication operation through the home IP network and generally controls an overall operation of the devices.

A CDS information browsing unit 402 performs an acquisition request of the CDS information to the DMS, and displays a browsing screen of the acquired CDS information. For example, when it is desired to acquire a list of content that is providable by the DMS (or acquirable through the DMS) as the CDS information, a content list screen is displayed, and the user can select content that the user wishes to reproduce/output, through the list screen.

A content acquisition unit 403 transmits an acquisition request of the content selected by the user to the DMS, and acquires the content. A content decoding unit 404 then decodes the acquired content, and a content reproduction output unit 405 reproduces/outputs the decoded content.

FIG. 5 schematically illustrates a functional configuration of a device that operates as the DMC in FIG. 2. Hereinafter, each unit will be described.

A communication control unit 501 controls a communication operation through the home IP network and generally controls an overall operation of the devices.

A CDS information browsing unit 502 performs an acquisition request of the CDS information to the DMS, and displays a browsing screen of the acquired CDS information.

For example, when it is desired to acquire a list of content that is providable by the DMS (or acquirable through the DMS) as the CDS information, a content list screen is displayed, and the user can select content that the user wishes to reproduce/output, through the list screen.

A content reproduction request unit 503 requests reproduction/output of the content selected by the user to the DMR.

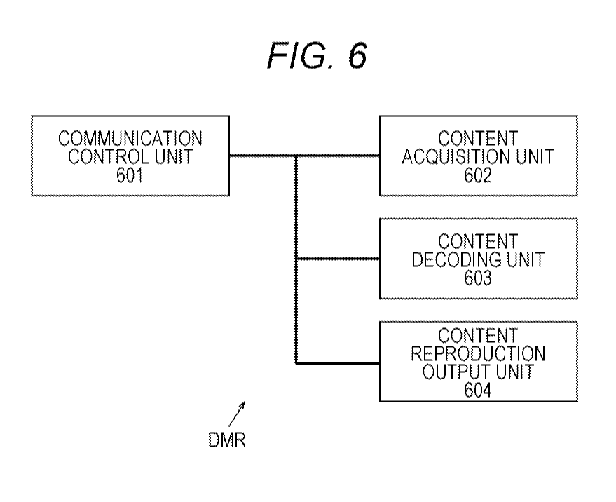

FIG. 6 schematically illustrates a functional configuration of a device that operates as the DMR in FIG. 2. Hereinafter, each unit will be described.

A communication control unit 601 controls a communication operation through the home IP network and generally controls an overall operation of the devices.

A content acquisition unit 602 transmits, to the DMS, an acquisition request of the content that the DMC has requested the reproduction and acquires the content. A content decoding unit 603 then decodes the acquired content, and a content reproduction output unit 604 reproduces and outputs the decoded content.

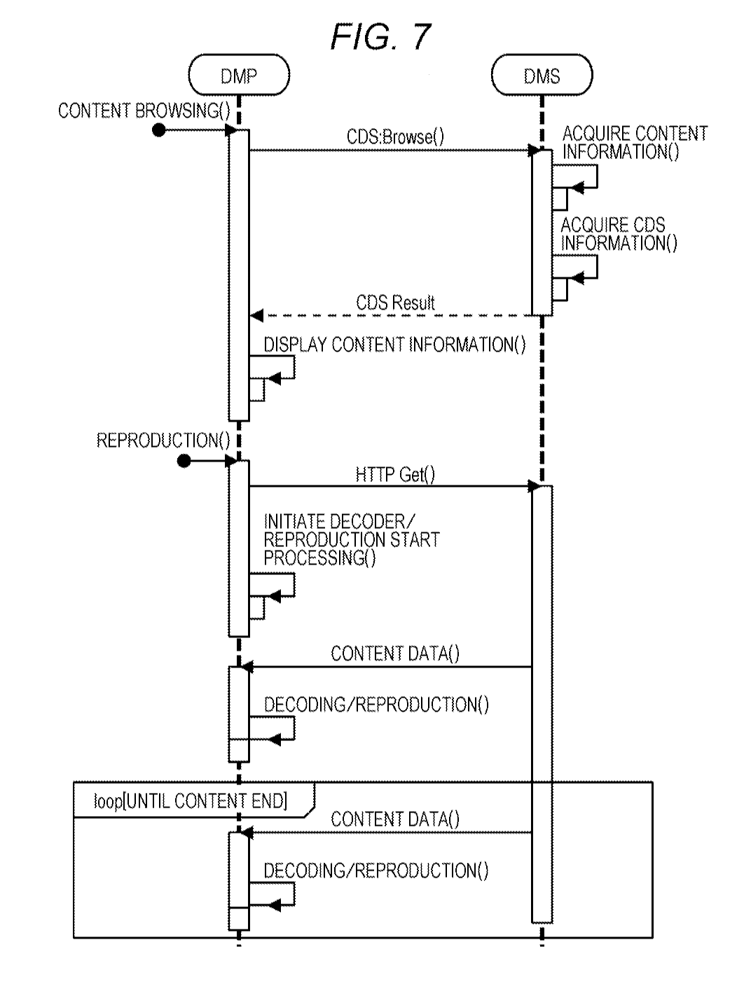

FIG. 7 illustrates an example of a communication sequence for performing content browsing and content reproduction by the DMP when the DMS delivers content stored in the own storage (content accumulation unit 302) to the DMP in the 2-Box Pull System Usage illustrated in FIG. 1.

In the content browsing, a CDS: Browse action is issued from the CDS information browsing unit 402 of the DMP to the DMS.

At the DMS side, the CDS: Browse action has been issued to the content stored in the content accumulation unit 302 as the own storage. Therefore, the CDS information generation unit 305 acquires all pieces of acquirable content information related to the content from the internal database of the content accumulation unit 302, generates the CDS information having a sufficient information amount, and stores the information in the CDS information storage unit 306. Further, the CDS information providing unit 307 returns the generated CDS information to the DMP as a CDS Result.

At the DMP side, the CDS information browsing unit 402 analyzes the received CDS Result, and displays content information including a title and detailed information of the content. The user of the DMP can select content that the user wishes to reproduce from the list of content.

At the reproduction, the content is requested from the content acquisition unit 403 of the DMP using a HTTP Get method, for example. At the DMS side, when having received the HTTP Get request, the content providing unit 304 returns (delivers) the content data stored in the content accumulation unit 302 that is the own storage to the DMP by a constant capacity. Then, at the DMP side, the content decoding unit 404 decodes the received data, and the content reproduction output unit 405 reproduces the decoded data. Until reaching the end of the content data, the delivery of the content data from the DMS and the decoding and reproduction of the content at the DMP side are repeated.

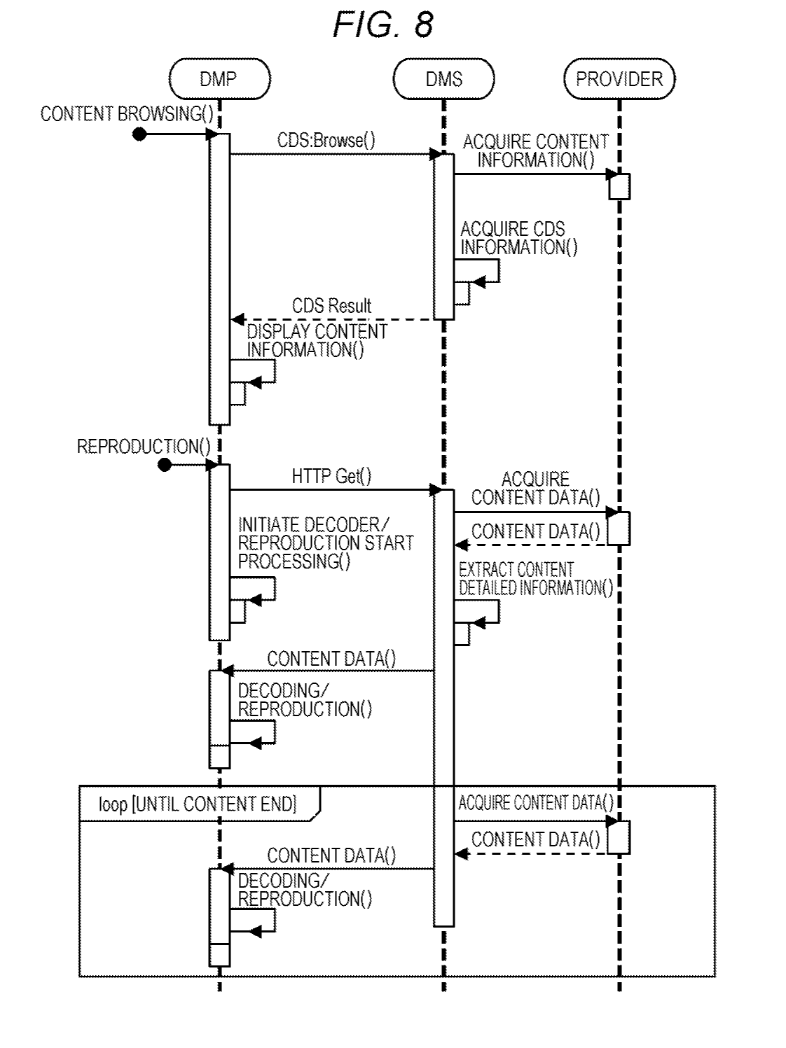

Meanwhile, FIG. 8 illustrates an example of a communication sequence for performing content browsing and content reproduction by the DMP when the DMS delivers the live content acquired from the provider to the DMP in the 2-Box Pull System Usage illustrated in FIG. 1.

In the content browsing, a CDS: Browse action related to the live content is issued from the CDS information browsing unit 402 of the DMP to the DMS.

At the DMS side, the CDS: Browse action has been issued to the live content, that is, to content that is not stored in the content accumulation unit 302 that is the own storage. Therefore, the CDS information generation unit 305 acquires the content information from the provider who provides appropriate content, generates the CDS information, and stores the information in the CDS information storage unit 306. Although it varies according to the provider, in most cases, only limited information such as a title of the content can be acquired. Therefore, the CDS information generation unit 305 can only generate the CDS information made of limited information. The CDS information providing unit 307 then returns the generated CDS information to the DMP as a CDS Result.

At the DMP side, the CDS information browsing unit 402 analyzes the received CDS Result, and displays content information made of limited information such as a title of the content. The user of the DMP can select content that the user wishes to reproduce from the list of content.

At the reproduction, the content is requested from the content acquisition unit 403 of the DMP using a HTTP Get method, for example. At the DMS side, when having received the HTTP Get request to the live content, the content acquisition unit 303 access the provider and acquires the content data. The content providing unit 304 then returns (delivers) data of the live content acquired from the provider to the DMP by a constant capacity. At the DMP side, the content decoding unit 404 decodes the received data, and the content reproduction output unit 405 reproduces the decoded data. Until reaching the end of the content data, the acquisition of the content data from the provider, the delivery of the content data from the DMS to the DMS, and the decoding and reproduction of the content at the DMP side are repeated.

The DMS can obtain detailed information (hereinafter, referred to as “content detailed information”) such as artist information related to the live content if actually acquires the content data itself. However, under the current standard specification of DLNA, there is no scheme that the content information delivered by the DMS is acquired by the DMP. Therefore, the DMP side cannot obtain the content detailed information related to the live content. In the end, the user of the DMP can only acquire the CDS information made of limited information during content browsing.

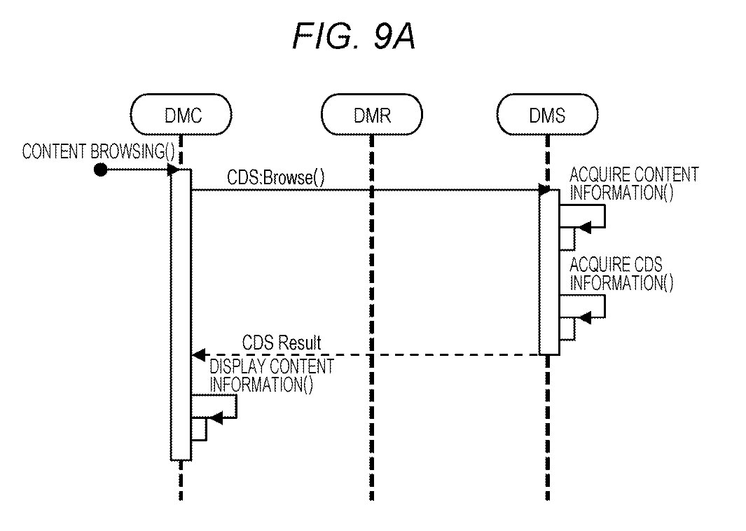

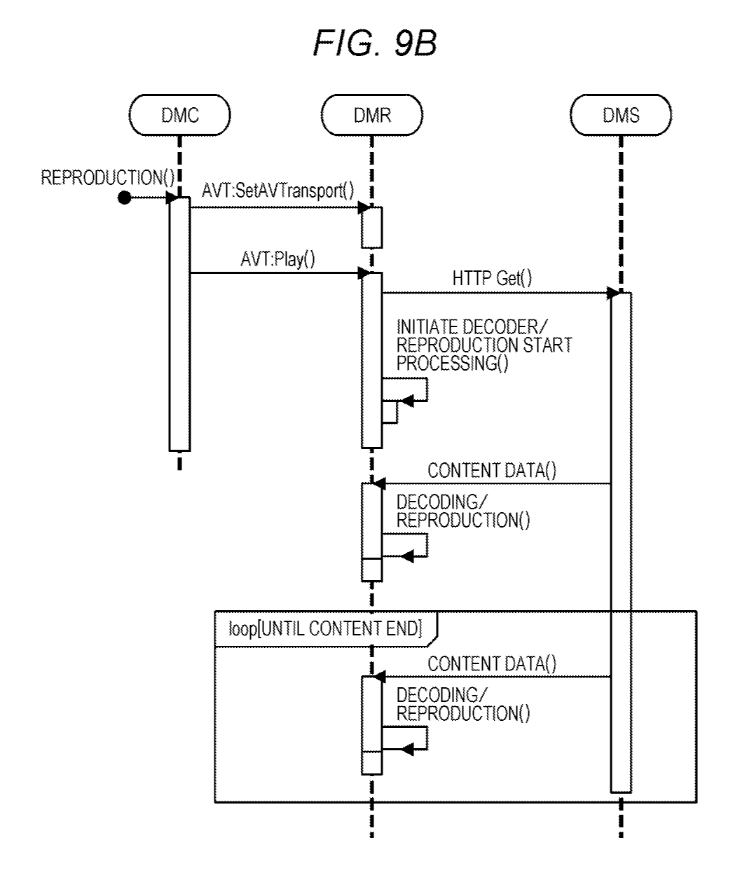

FIGS. 9A and 9B illustrate examples of communication sequences for performing content browsing in the DMC and content reproduction in the DMR when the DMS delivers content stored in the own storage in the 3-Box System Usage.

In the content browsing, a CDS: Browse action is issued from the CDS information browsing unit 502 of the DMC to the DMS, as illustrated in FIG. 9A.

At the DMS side, the CDS: Browse action has been issued to the content stored in the content accumulation unit 302 that is the own storage. Therefore, the CDS information generation unit 305 acquires all pieces of acquirable content information related to the content from the internal database of the content accumulation unit 302, generates the CDS information having a sufficient information amount, and stores the information in the CDS information storage unit 306. Further, the CDS information providing unit 307 returns the generated CDS information to the DMP as a CDS Result.

At the DMC side, the CDS information browsing unit 502 analyzes the received CDS Result, and displays content information including a title and detailed information of the content. The user of the DMP can select content that the user wishes to reproduce from the list of content.

At the reproduction, as illustrated in FIG. 9B, the content reproduction request unit 503 of the DMC issues an AVT: SetAVTransportURI( ) action to the DMR and notifies attribute information of the selected content. The attribute information of the content includes a title of the content, a size of the content, a length of the content, a uniform resource locator (URL) for accessing the content, and the like. The content reproduction request unit 503 further issues an AVT: Play( ) action to the DMR, and requests start of reproduction of the content.

The content acquisition unit 602 of the DMR requests the content using the HTTP Get method in response to the reproduction start request of the content. At the DMS side, when having received the HTTP Get request, the content providing unit 304 returns (delivers) the content data stored in the content accumulation unit 302 that is the own storage to the DMP by a constant capacity. At the DMR side, the content decoding unit 603 then decodes the received data, and the content reproduction output unit 604 reproduces the decoded data. Until reaching the end of the content data, the delivery of the content data from the DMS and the decoding and reproduction of the content at the DMR side are repeated.

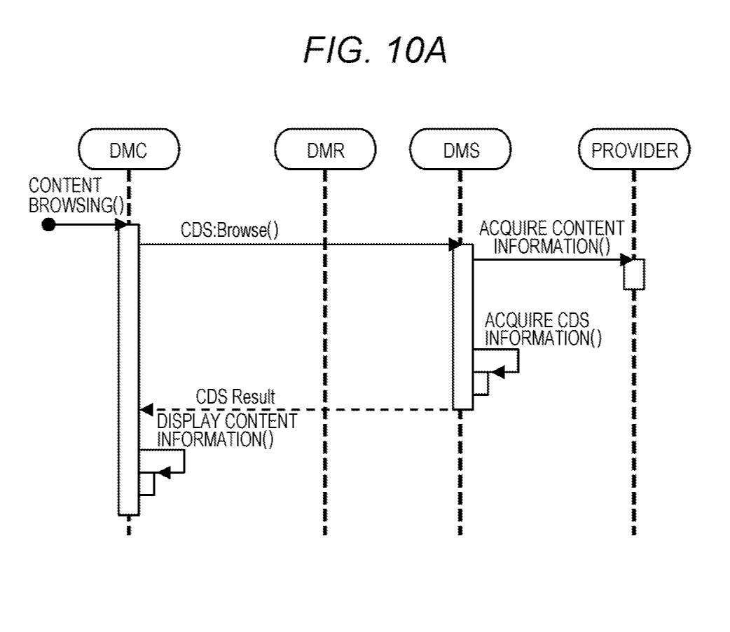

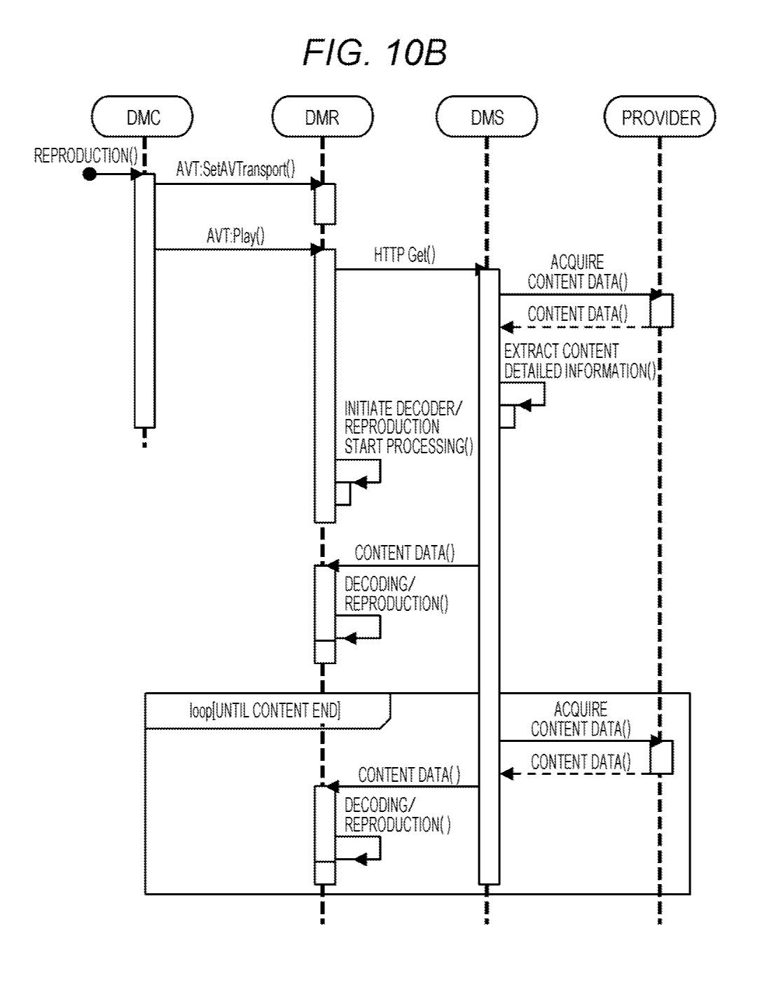

Meanwhile, FIGS. 10A and 10B illustrate examples of communication sequences for content browsing in the DMC and content reproduction in the DMR when the DMS delivers live content acquired from the provider in the 3-Box System Usage.

In the content browsing, a CDS: Browse action is issued from the CDS information browsing unit 502 of the DMC to the DMS, as illustrated in FIG. 10A.

At the DMS side, the CDS: Browse action has been issued to the live content, that is, to content that is not stored in the content accumulation unit 302 as the own storage. Therefore, the CDS information generation unit 305 acquires the content information from the provider who provides appropriate content, generates the CDS information, and stores the information in the CDS information storage unit 306. Although it varies according to the provider, in most cases, only limited information such as a title of the content can be acquired. Therefore, the CDS information generation unit 305 can only generate the CDS information made of limited information. The CDS information providing unit 307 then returns the generated CDS information to the DMC as a CDS Result.

At the DMC side, the CDS information browsing unit 502 analyzes the received CDS Result, and displays content information made of limited information such as a title of the content. The user of the DMC can select content that the user wishes to reproduce from the list of content.

At the reproduction, as illustrated in FIG. 10B, the content reproduction request unit 503 of the DMC issues an AVT: SetAVTransportURI( ) action to the DMR and notifies attribute information of the selected content. The attribute information of the content includes a title of the content, a size of the content, a length of the content, a uniform resource locator (URL) for accessing the content, and the like. The content reproduction request unit 503 further issues an AVT: Play( ) action to the DMR, and requests start of reproduction of the content.

The content acquisition unit 602 of the DMR requests the content using the HTTP Get method in response to the reproduction start request of the content. At the DMS side, when having received the HTTP Get request, the content acquisition unit 303 acquires content data of the live content from the provider by a constant capacity, and the content providing unit returns (delivers) the data to the DMR. At the DMR side, the content decoding unit 603 then decodes the received data, and the content reproduction output unit 604 reproduces the decoded data. Until reaching the end of the content data, the acquisition of the content data from the provider, the delivery of the content data from the DMS to the DMS, and the decoding and reproduction of the content at the DMP side are repeated.

The DMS can obtain content detailed information related to the live content if actually acquires the content data itself. However, under the current standard specification of DLNA, there is no scheme that the content information delivered by the DMS is acquired by the DMC. Therefore, the DMC side cannot obtain the content detailed information related to the live content. In the end, the user of the DMC can only acquire the CDS information made of limited information during content browsing.

To sum up FIGS. 8 and 10, the CDS standard is formulated on the assumption that the DMS stores the content to be delivered in the own storage, and does not cover the content detailed information related to the live content, and the current standard specification of DLNA does not have a scheme in which the DMP and the DMC acquire the content information delivered by the DMS. Therefore, the user of the DMP and the DMC can only acquire the CDS information made of limited information regarding the live content.

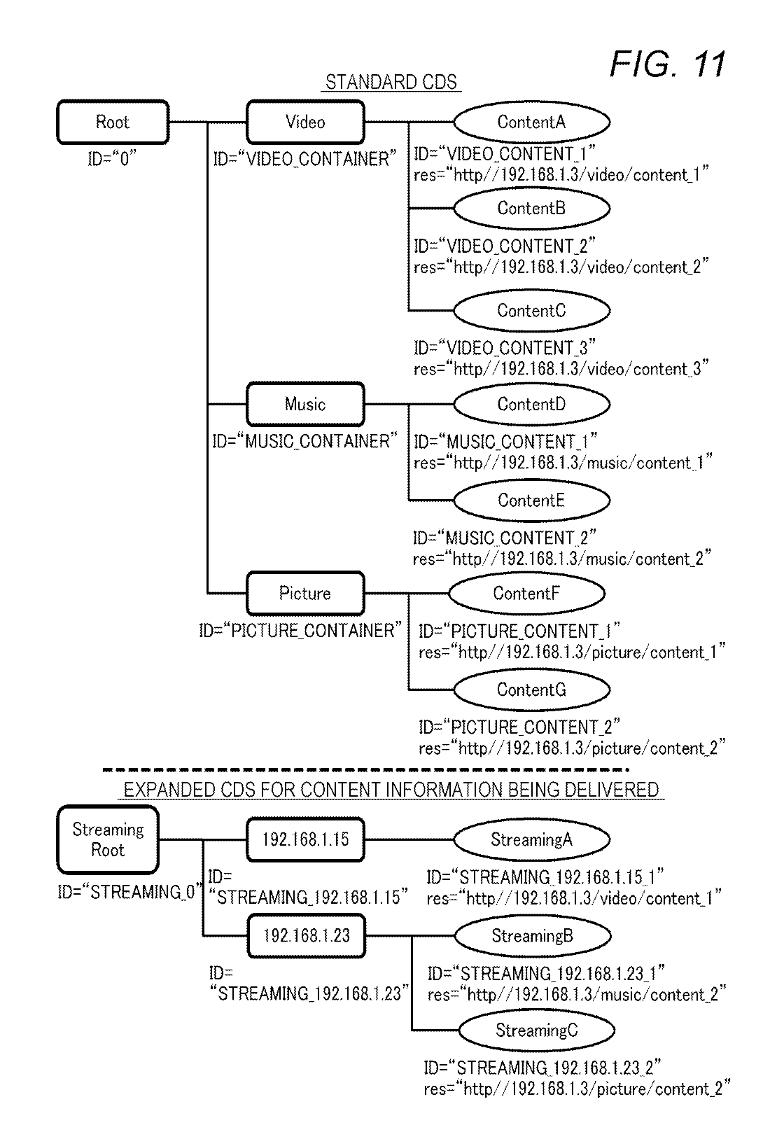

Therefore, the present specification proposes a CDS configuration of the DMS, in which the user of the DMP and the DMC can acquire content detailed information even regarding the live content. CDS information according to the present proposal includes, as illustrated in FIG. 11, a CDS tree for including content detailed information of content being delivered, separately from a CDS tree accessed during content browsing. The latter CDS tree is a typical CDS tree incorporated in the current DLNA, and is hereinafter referred to as a “standard CDS”. Further, the former CDS tree for describing the content detailed information of content being delivered is hereinafter referred to as an “expanded CDS for content information being delivered”.

An ObjectID of the standard CDS is configured in a way that each container is arranged directly under a root of 0 (fixed). In contrast, as for the expanded CDS for content information being delivered, a unique ObjectID is defined (in the illustrated example, “STREAMING_{—}0”), and a root for content being delivered, which includes the unique ObjectID (hereinafter, referred to as “StreamingRoot”) is provided, and a tree is configured with the root as a base.

In this way, the expanded CDS for content information being delivered is configured independently of the standard CDS, so that the standard CDS that can basically only includes the static information, and the expanded CDS for content information being delivered that is dynamically changed every time being delivered, are separated, and the expanded CDS for content information being delivered cannot be accessed during content browsing.

Here, the minimum unit of content, such as one piece of music data (song), one piece of video data, and one piece of picture data, is called an item (item). In the case of live content, one channel is treated as one item. In addition, a superior object of an item defined as a set of the above-described items is called a container. The unit of set can be set to various sets, for example, a set based on physical storage positions of objects, a set based on logical relationship of the objects, a set based on categories, and the like.

In the example illustrated in FIG. 11, the unit of set of the standard CDS is a media category. Container nodes: Video, Music, and Picture for each type of medium are provided directly under the root of the standard CDS. The container nodes have respective ObjectIDs: “VIDEO_CONTAINER”, “MUSIC_CONTAINER”, and “PICTURE_CONTAINER”, with which the type of medium can be identified. Further, the content nodes (items) of a video, music, a picture are arranged under the respective container nodes: Video, Music, and Picture. Each content node includes res information that corresponds to a URL designated by the HTTP Get method.

Meanwhile, the unit of set of the expanded CDS for content information being delivered is a client of delivery destination, and a container for each client of delivery destination (hereinafter, referred to as “delivery destination container node”) is provided. A content node being delivered for storing the content detailed information is arranged as an item under each delivery destination container node. This is applicable for the DMS capable of delivering a plurality of pieces of content (to a plurality of clients) simultaneously. Note that each node of the expanded CDS for content information being delivered is generated when delivery is started, and is discarded when the delivery is completed.

The delivery destination container node can be identified by an IP address or a MAC address (by an IP address in the example of FIG. 11), and the content node being delivered under the delivery destination container node is associated with the content node of the standard CDS side. In the present proposal, as the ObjectID of the delivery destination container node, the IP address of the delivery destination client is added after the prefix “STREAMING”. Further, the content node being delivered can be associated with the content of the standard CDS by the res information that corresponds to the URL identified by the client by the HTTP Get method at the reproduction.

The server (DMS) and the client (DMP and DMC) share the rule (regulation) of the expanded CDS for content information being delivered described above, so that the client can identify information of the expanded CDS for content information being delivered of the content that the client itself is reproducing. To be specific, the client first generate an ObjectID of the intended delivery destination container node from the own IP address, performs a CDS: Browse action of the delivery destination container node using the ObjectID as an argument, and identifies a delivery destination content node having res information according with the URL of the content that the client itself is reproducing from the CDS Result returned from the server.

When the DMS acquires the content data of the live content from the provider, the DMS can extract the content detailed information and can write the information on the expanded CDS for content information being delivered. Meanwhile, if the client such as the DMP and DMC access the information of the expanded CDS for content information being delivered of the content that the client itself is reproducing, the client can acquire the content detailed information that the client was not able to acquire during content browsing.

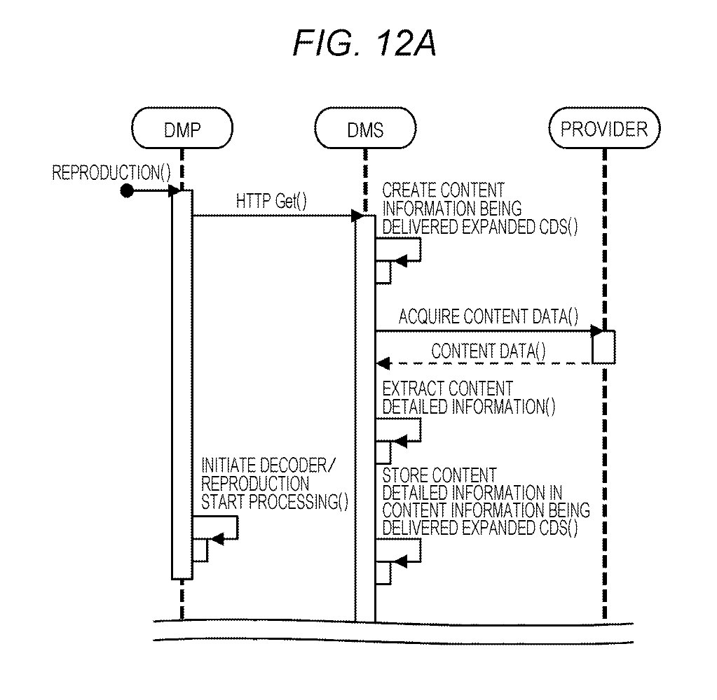

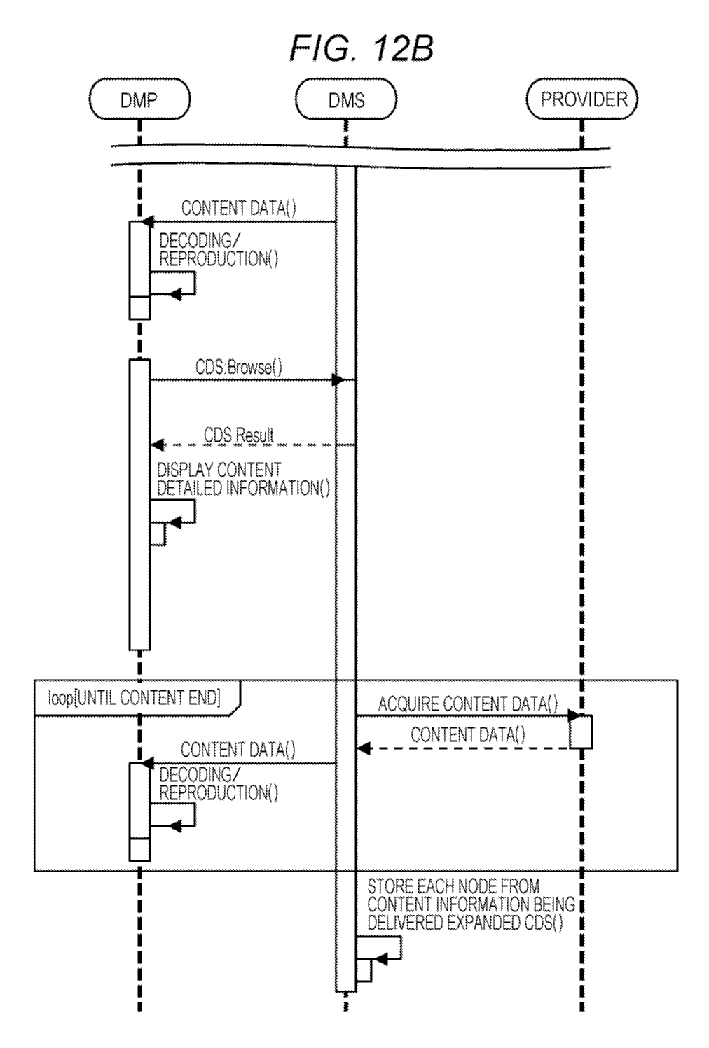

FIGS. 12A and 12B illustrate examples of communication sequences in which the DMP performs content reproduction when the DMS delivers live content acquired from the provider to the DMP in the 2-Box Pull System Usage illustrated in FIG. 1. This example is different from the communication sequence example illustrated in FIG. 8 in that, at the content reproduction, the DMS stores the content detailed information regarding the live content in the expanded CDS for content information being delivered, and releases the information to the DMP.

The communication sequence for content browsing performed by the DMP is similar to that in FIG. 8. Therefore, illustration is omitted in FIG. 12. That is, in the content browsing, a CDS: Browse action related to the live content is issued from the CDS information browsing unit 402 of the DMP to the DMS. In response, at the DMS side, the CDS information generation unit 305 acquires the content information from the provider who provides appropriate content and generates the CDS information, and the CDS information providing unit 307 returns the generated information as CDS Result.

At the reproduction, the content is requested from the content acquisition unit 403 of the DMP using a HTTP Get method, for example. At the DMS side, when having received the HTTP Get request to the live content, the CDS information generation unit 305 first generates the expanded CDS for content information being delivered in the CDS information storage unit 306. Then, a delivery destination container node is created from the IP address of the HTTP Get requestor, and a content node being delivered is created under the delivery destination container node. Note that it is not necessary to create the delivery destination content if it is being delivered to the same client and has already been created.

Following that, the content acquisition unit 303 accesses the provider and acquires the content data. When having extracted content detailed information from the acquired content data, the CDS information generation unit 305 stores the content detailed information in the content node being delivered and releases the information. Note that the content detailed information may be acquired by issuance of another dedicated command by the provider, or may be included in the content data. In the latter case, it is necessary to extract the content data in decoding.

The content acquisition unit 303 acquires the content data of the live content from the provider by a constant capacity, and the content providing unit 304 returns (delivers) the data to the DMP. At the DMP side, the content decoding unit 404 decodes the received data, and the content reproduction output unit 405 reproduces the decoded data.

Here, at the stage where the DMP outputs the HTTP Get request and the delivery of the live content form the DMS has been started, the DMP issues the CDS: Browse action to the expanded CDS for content information being delivered, so that the DMP can acquire the content detailed information of the live content that the DMS is delivering and that the DMP itself is reproducing, and can use the information for display. The DMP generates the ObjectID of the indented delivery destination container node from the own IP address in issuing the CDS: Browse action (described above). At the DMS side, when having received the CDS: Browse action, the CDS information providing unit 307 identifies an appropriate container node being delivered from the expanded CDS for content information being delivered based on the ObjectID, and returns the content detailed information stored therein to the DMP as a CDS Result

Until reaching the end of the content data, the acquisition of the content data from the provider, the delivery of the content data from the DMS to the DMS, and the decoding and reproduction of the content at the DMP side are repeated. When the delivery of the live content is completed, the DMS side discards appropriate delivery destination container node and content node being delivered among the expanded CDS for content information being delivered from the CDS information storage unit 306.

By expanding the CDS information in this way, even in a case where the content detailed information cannot be acquired without actually receiving the services and broadcasting content, the DMP can acquire the content detailed information.

Further, the details of expansion are that the expanded CDS for content information being delivered is simply provided, and it is not necessary to change the protocol of the command (action) to be used. Therefore, burden on implementation to the DMS and DMP is not large.

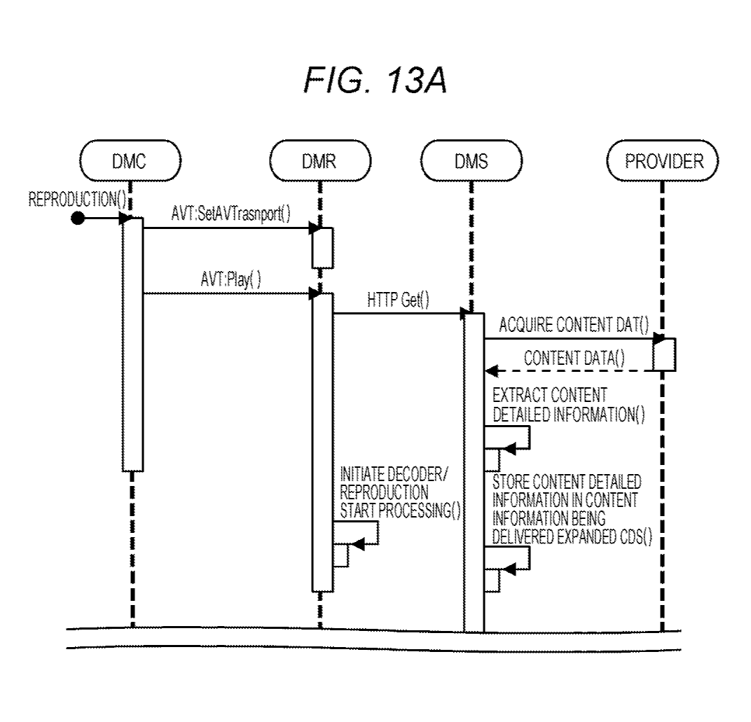

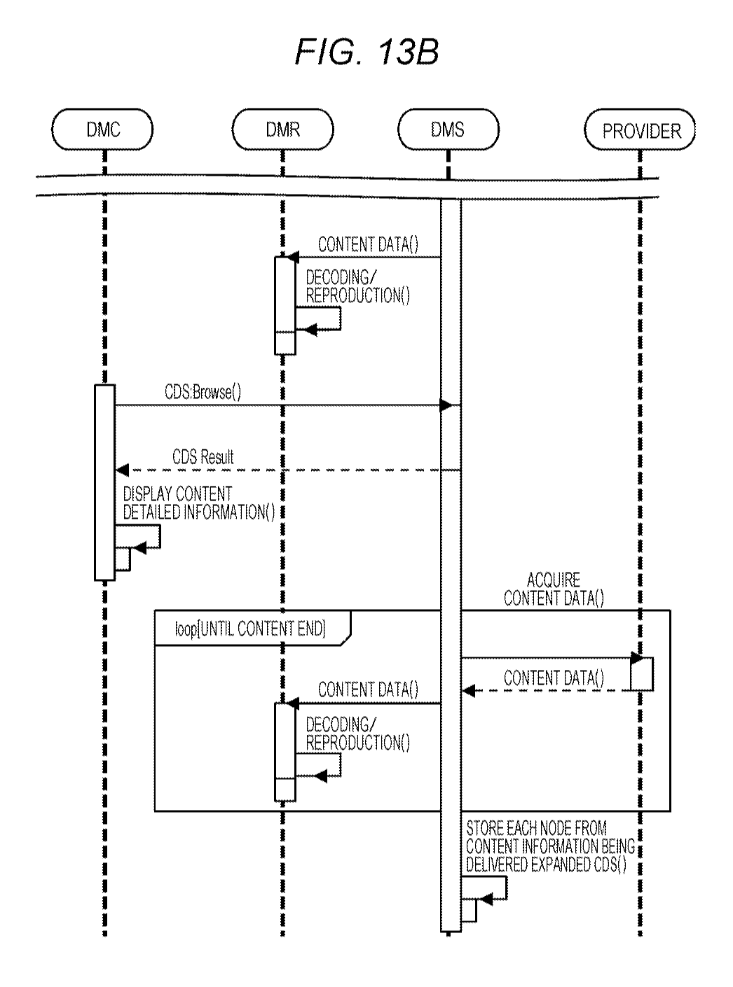

Further, FIGS. 13A and 13B illustrate examples of communication sequences in which content reproduction is performed in the DMR when the DMS delivers live content acquired from the provider in the 3-Box System Usage. This example is different from the communication sequence example illustrated in FIG. 10B in that, at the content reproduction, the DMS stores the content detailed information regarding the live content in the expanded CDS for content information being delivered, and releases the information to the DMC.

The communication sequence for content browsing performed by the DMP is similar to that in FIG. 10A. Therefore, illustration is omitted here. That is, in content browsing, a CDS: Browse action is issued from the CDS information browsing unit 502 of the DMC to the DMS. At the DMS side, the CDS information generation unit 305 acquires the content information from the provider who provides appropriate content and generates the CDS information. The CDS information providing unit 307 then returns the generated CDS information to the DMC as a CDS Result.

At the reproduction, the content reproduction request unit 503 of the DMC issues an AVT: SetAVTransportURI( ) action to the DMR, and notifies attribute information of the selected content. The content reproduction request unit 503 further issues an AVT: Play( ) action to the DMR, and requests start of reproduction of the content.

The content acquisition unit 602 of the DMR requests the content using the HTTP Get method in response to the reproduction start request of the content. At the DMS side, when having received the HTTP Get request to the live content, the CDS information generation unit 305 first generates the expanded CDS for content information being delivered in the CDS information storage unit 306. Then, a delivery destination container node is created from the IP address of the HTTP Get requestor, and a content node being delivered is created under the delivery destination container node. Note that it is not necessary to create the delivery destination content if it is being delivered to the same client and has already been created.

Following that, the content acquisition unit 303 accesses the provider and acquires the content data. When having extracted content detailed information from the acquired content data, the CDS information generation unit 305 stores and releases the content detailed information in the content node being delivered. Note that the content detailed information may be acquired by issuance of another dedicated command by the provider, or may be included in the content data. In the latter case, it is necessary to extract the content data in decoding.

The content acquisition unit 303 acquires the content data of the live content from the provider by a constant capacity, and the content providing unit 304 returns (delivers) the data to the DMR. At the DMR side, the content decoding unit 603 then decodes the received data, and the content reproduction output unit 604 reproduces the decoded data.

Here, at the stage where the DMR outputs the HTTP Get request and delivery of the live content is started from the DMS, the DMC issues the CDS: Browse action to the expanded CDS for content information being delivered, so that the DMC can acquire the content detailed information of the live content that the DMS is delivering and the DMC itself is reproducing, and can use the information for display. The DMC generates the ObjectID of the indented delivery destination container node from the own IP address in issuing the CDS: Browse action (described above). At the DMS side, when having received the CDS: Browse action, the CDS information providing unit 307 identifies an appropriate container node being delivered from the expanded CDS for content information being delivered based on the ObjectID, and returns the content detailed information stored therein to the DMC as a CDS Result.

Until reaching the end of the content data, the acquisition of the content data from the provider, the delivery of the content data from the DMS to the DMS, and the decoding and reproduction of the content at the DMP side are repeated. When the delivery of the live content is completed, the DMS side discards appropriate delivery destination container node and content node being delivered among the expanded CDS for content information being delivered from the CDS information storage unit 306.

By expanding the CDS information in this way, even in a case where the content detailed information cannot be acquired without actually receiving the services and broadcasting content, the DMC can acquire the content detailed information.

Further, the detail of expansion is simply providing the expanded CDS for content information being delivered, and it is not necessary to change the protocol of the command (action) to be used. Therefore, burden on implementation to the DMS, DMC, and DMR is not large.

As can be seen from FIGS. 12 and 13, according to the present proposal, the DMS receives the content detailed information in real-time related to the live content currently being delivered, and delivers the information to the client, so that the client side such as the DMP and the DMR can display the content detailed information similar to the case where the content is directly received. That is, in the 2-Box Pull and the 3-Box System Usage, the usability in delivering live content can be improved.

### INDUSTRIAL APPLICABILITY

As described above, specific embodiments concerning the technology disclosed in the present specification have been described in detail. However, it will be obvious to those skilled in the art that modifications and changes may be made without departing from the spirit and scope of the technology disclosed in the present specification.

In the present specification, in the 2-Box Pull and the 3-Box System. Usage of DLNA, an embodiment in a case where the DMS delivers live content has been mainly described. However, even if the DMS delivers the content stored in the own storage, the expanded CDS for content information being delivered can be similarly generated, and can release the content detailed information to the client.

Further, in the present specification, embodiments in which the present proposal is applied to the 2-Box Pull and the 3-Box System Usage of DLNA have been mainly described. However, the present proposal can be of course similarly applied to various types of communication systems incorporating the CDS function therein other than DLNA.

In short, the technology disclosed in the present specification has been disclosed in a form of example, and the contents of the description of the present specification should not be construed in a limited manner. The scope of the invention is to be determined in view of claims.

### REFERENCE SIGNS LIST

301 Communication control unit
302 Content accumulation unit
303 Content acquisition unit
304 Content providing unit
305 CDS information generation unit
306 CDS information storage unit
307 CDS information providing unit
401 Communication control unit
402 CDS information browsing unit
403 Content acquisition unit
404 Content decoding unit
405 Content reproduction output unit
501 Communication control unit
502 CDS information browsing unit
503 Content reproduction request unit
601 Communication control unit
602 Content acquisition unit
603 Content decoding unit
604 Content reproduction output unit

1. A communication system comprising:
a server configured to operate in accordance with DLNA standard to deliver content; and
a client configured to operate in accordance with the DLNA standard to request delivery of content,
wherein the server creates an expanded CDS for content information being delivered in which a delivery destination container node having an ObjectID based on information identifying the client is arranged directly under a root, and a content node being delivered is arranged under the delivery destination container node, and extracts content detailed information from content that has acquired to deliver to the client and stores the content detailed information in the content node being delivered.

2. A communication device configured to operate as a server in accordance with DLNA standard, comprising:
a communication unit configured to communicate with an external device;
a content acquisition unit configured to acquire content requested from a client;
a content providing unit configured to deliver the content to the client;
a CDS information generation unit configured to generate CDS information related to the content; and
a CDS information providing unit configured to transmit the CDS information by a request from the client,
wherein, in response to a request of providing content from the client, the CDS information generation unit arranges a delivery destination container node having an ObjectID based on information identifying the client directly under a root of an expanded CDS for content information being delivered, and creates a content node being delivered under the delivery destination container node, and extracts content detailed information from the content acquired by the content acquisition unit and stores the content detailed information in the content node being delivered, and
in response to a request of CDS information from the client to which the content providing unit is delivering the content, the CDS information providing unit transmits CDS information including the content detailed information stored in the appropriate content node being delivered.

3. The communication device according to claim 2, wherein the content node being delivered has res information that accords with a URL of the content.

4. The communication device according to claim 2, wherein, when the content providing unit completes delivery of the content to the client, each node is deleted from the expanded CDS for delivery content information.

5. The communication device according to claim 2, wherein
the content acquisition unit acquires live content from a provider over an outside network through the communication unit, and
when the live content is requested from the client, the CDS information generation unit creates the delivery destination container node and the content node being delivered in the expanded CDS for content information being delivered.

6. The communication device according to claim 2, further comprising:
a content accumulation unit configured to accumulate content to be provided to the client,
wherein, when the content accumulated in the content accumulation unit is requested from the client, the CDS information generation unit creates the delivery destination container node and the content node being delivered in the expanded CDS for content information being delivered.

7. A communication device configured to operate as a client in accordance with DLNA standard, at least comprising:
a communication unit configured to communicate with a device that is in accordance with the DLNA standard; and
a CDS information browsing unit configured to request browsing of CDS information to a server that is in accordance with the DLNA standard,
wherein the CDS information browsing unit generates an ObjectID based on information identifying the CDS information browsing unit itself, and requests browsing of CDS information to the server using the ObjectID.

8. The communication device according to claim 7, wherein the communication device is a DMP defined in the DLNA standard, and further includes a content acquisition unit configured to request content to the server to acquire the content, a content decoding unit configured to decode the content, and a content reproduction output unit configured to reproduce/output the decoded content, and
when the content acquisition unit requests live content provided by a provider to the server, the CDS information browsing unit generates an ObjectID based on information identifying the CDS information browsing unit itself, and requests browsing of CDS information to the server using the ObjectID.

9. The communication device according to claim 7, wherein the communication device is a DMC defined in the DLNA standard, and further includes a content reproduction request unit configured to request reproduction/output of content to a renderer, and
when the content reproduction request unit requests reproduction of live content provided by a provider to the renderer, the CDS information browsing unit generates an ObjectID based on information identifying the CDS information browsing unit itself, and requests browsing of CDS information to the server using the ObjectID.

10. A communication method for operating as a server in accordance with DLNA standard, the method comprising:
a step of arranging a delivery destination container node having an ObjectID based on information identifying a client directly under a root of an expanded CDS for content information being delivered, and creating a content node being delivered under the delivery destination container node, in response to a request of providing content from the client;
a step of acquiring the content requested from the client;
a step of extracting content detailed information from the acquired content and storing the extracted content detailed information in the content node being delivered;
a step of delivering the acquired content to the client; and
a step of transmitting CDS information including the content detailed information stored in the appropriate content node being delivered, in response to a request of CDS information from the client to which the content is being delivered.

11. A communication method for operating as a client in accordance with DLNA standard, the method comprising:
a step of generating an ObjectID based on information identifying a communication device itself; and
a step of requesting browsing of CDS information to the server using the ObjectID.
